(19) United States
(12) Patent Application Publication
(10) Pub. No.: US 2017/0343123 A1
(43) Pub. Date: Nov. 30, 2017

(54) Check Valve for Submersible Pump

(71) Applicant: Strataflo Products, Inc., Fort Wayne, IN (US)

(72) Inventor: Bradley A. Fudge, Columbia City, IN (US)

(21) Appl. No.: 15/606,746

(22) Filed: May 26, 2017

Related U.S. Application Data
(60) Provisional application No. 62/343,661, filed on May 31, 2016.

(51) Int. Cl. F16K 15/06; F16K 1/52; F16K 1/30; F16K 1/32

(52) U.S. Cl. CPC F16K 15/063; F16K 1/303; F16K 1/526; F16K 1/301; F16K 1/32; F16K 1/307

(57) ABSTRACT

The present invention comprises a unibody check valve for detachable use with a submersible pump, said check valve comprising a unibody housing with an inlet and an outlet defining a fluid passage, where a portion of the face of the outlet comprises a poppet seat, and a poppet stem enclosing member held in axial alignment with the fluid passage by one or more supporting members, a poppet slidably retained within said poppet stem enclosing member, and a biasing member captured between the one or more supporting members and a poppet stem base, where the biasing member biases the poppet head into a closed position against the seat when liquid flow is not sufficient to overcome the force of the biasing member, and where the poppet head is pushed away from the seat when liquid flow is sufficient to overcome the force of the biasing member.

### CROSS-REFERENCE TO RELATED APPLICATION

This Application is a non-provisional continuation of, and incorporates in its entirety, previously-filed U.S. Provisional Application Ser. No. 62/343,661 Check Valve for Submersible Pump, and incorporates the same in its entirety.

### BACKGROUND

This invention relates to controlling flow of fluids in a liquid or gas system, and more particularly to a check valve for use in the unidirectional delivery of fluid liquid or fluid gas under pressure from the outlet of a pump, and particularly a submersible pump, to a location outside of the outlet, without allowing substantial backflow of the fluid liquid or fluid gas into the pump.

Check valves are in widespread use for permitting fluids to flow through a passage in one direction while preventing flow in the reverse direction, including in the context of submersible pumps. Most check valves employ a movable poppet urged by a spring to engage a valve seat, thereby closing the valve. When force is exerted against the face of the poppet by fluid in the system moving in the direction permitted by the check valve, and that pressure exceeds the force of the spring, the poppet moves away from the seat, opening the valve.

Check valves are used in a variety of applications. In the application of submersible pumps, particularly submersible pumps for wells, backflow preventative structures are permanently built into the pump outlet. These structures are commonly recognized as insufficient to prevent backflow adequately under the working conditions submersible pumps are often subjected to. As a result, there exists a need in the art for an external check valve, capable of regulating backflow adequately in the normal operating conditions of a submersible pump within a well, and configurable to fit within the outlets of a variety of manufacturers' submersible pumps.

In general use, and particularly in the application of a submersible pump, an external check valve can be exposed to severe environmental conditions, including large pressure fluctuations, temperature fluctuations, and turbulent flow. In some applications, check valves are subjected to frequent forward and reverse flow cycles. Consequently, the poppet and other internal parts of check valves are in many applications subject to substantial vibrations which can result in noise, damage, or failure. Some valves of the prior art include a guide, sometimes called a retaining piece, mounted inside the valve for guiding and limiting movement of the poppet to prevent damage. In valves known to the art, retaining pieces are frequently located so that installation and replacement is difficult, or are flexible in construction or otherwise ill-suited for the severity of the environment. Further, the inaccessibility of the internal parts of check valves known to the art generally necessitates replacement of the entire valve assembly when only one part of the valve, such as the spring, fails.

Further, check valves known to the art are often purpose-built for connection to specifically-sized or specifically configured pipes or conduits. This limits the usefulness and versatility of check valves known to the art, as such valves can only be used in connection with the configuration of pipe or conduit for which they are built. Still further, check valves known to the art require a variety of fabrication techniques to make the different parts that comprise the valve assembly. Parts like the poppet or guide are often molded or cast, while parts like the housing are often machined. The variety of fabrication techniques requires to make the parts of a check valve increases the cost of the valve assembly.

It would a decided advantage to provide a check valve that allows convenient replacement of one or more parts internal to the valve, including specifically the poppet, spring, and retaining piece. It would further be a decided advantage to provide an improved check valve that can be easily adapted by a user for use with a variety of submersible pump outlets without requiring the purchase of an entire new valve assembly or a new pump. It would further be a decided advantage to provide a check valve wherein most parts can be produced by efficient fabrication techniques, such as machining.

### SUMMARY

Among the several objects of the embodiments of this invention are to provide an improved check valve that allows convenient replacement one or more parts internal to the valve, including specifically the poppet and retaining piece, to provide an improved check valve that can be easily adapted by a user for use with a variety of submersible pump outlets, and to provide a check valve wherein most parts can be machined, reducing the number of fabrication techniques required for the production of the check valve assembly.

In general, a submersible pump check valve according to the present invention comprises a unibody design with a fluid passage extending therethrough from an inlet constituting the end of the housing for entry of fluid under pressure to flow through to a an outlet constituting the end for exit of the housing for fluid under pressure. A portion of the first inlet, or the first outlet, comprises a poppet seat. The poppet assembly, which comprises a poppet with a head and a stem, a stem enclosure, and a biasing member, fits generally within the unibody design, and most preferably with an axial stem enclosure held in place by support members. The rear of the head of the poppet faces a seat in the first outlet, and the biasing member is retained in part by the stem base and the support members. The poppet stem engages slidably with the stem enclosure. When fluid under pressure flowing from the outlet of a submersible pump in the direction from the first inlet towards the first outlet encounters the poppet, the poppet slides away from the seat allowing fluid to enter the valve and pass through it. When pressure is removed, the biasing member pulls the poppet head back against the seat, substantially preventing the reverse flow of fluid back into the pump outlet. The unibody valve member further comprises external male threading, preferably of 1.25 inch diameter or other size as may be desired to fit within a submersible pump outlet.

In this way, embodiments of the present invention can be easily dis- and re-assembled for removal, replacement, or service of the internal parts. Further, most of the parts of check valves according to the teachings of the present invention can be manufactured by machining, reducing the need for multiple fabrication techniques. Additionally, check valves as taught herein can be placed within Additionally, one or more pieces of the check valves of the present invention can be replaced with pieces sized or otherwise configured to connect with pipes or conduits of different sizes or different configurations, allowing modularity and the ability to adapt the same valve to several different functions or applications without requiring replacement of the entire valve assembly.

### DESCRIPTION OF THE DRAWINGS

FIG. 1 shows a representative submersible pump in connection with which a check valve according to the present invention could be used;

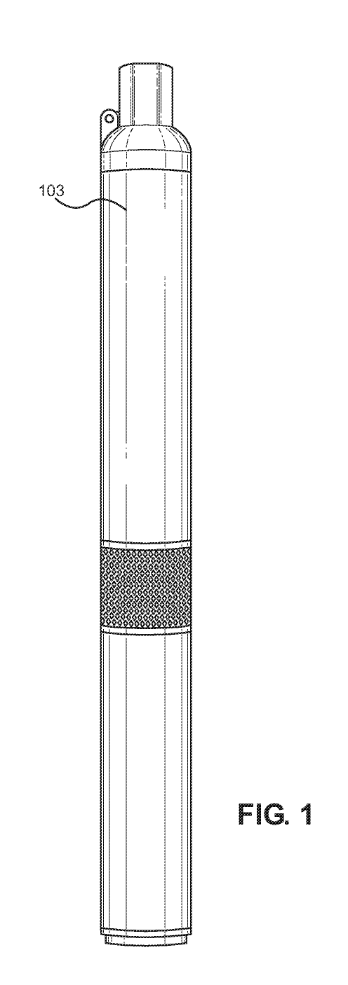

FIG. 2 shows a a cutaway view of a representative submersible pump with an embodiment of a check valve according to the present invention installed;

FIG. 3 shows a perspective view of one embodiment of a check valve according to the present invention;

FIG. 4 shows a reverse perspective view of one embodiment of a check valve according to the present invention;

FIG. 5 shows an exploded view of one embodiment of a check valve according to the present invention;

FIG. 6 shows a cross-sectional view of one embodiment of a check valve according to the present invention.

### DETAILED DESCRIPTION

In one embodiment, the check valve of the present invention comprises a three-piece assembly. In this embodiment, the check valve comprises a housing (1) with a first end (3) and a second end (5). The housing includes a fluid passage (7) that both connects said first end (3) to said second end (5) and passes through said first end (3) and said second end (5). The fluid passage (7) defines a void through the housing (1) through which fluid under pressure can pass. Although in some embodiments the fluid passage (7) is tubular, it will be appreciated by one skilled in the art that the fluid passage may assume a variety of internal cross-sectional configurations or shapes.

In these embodiments, a portion of the wall of the fluid passage comprises a shelf (9). The shelf (9) comprises a ledge, a protrusion, or multiple protrusions, optionally coplanar, within the fluid passage (7). In this embodiment, the shelf (9) comprises a ridge running substantially around the perimeter of the wall of the fluid passage (7). The shelf (9) may comprise a unitary structure running around the entirety of the perimeter of the wall of the fluid passage, or may alternatively comprise one or more inwardly depending protrusions from the wall of the fluid passage that do not run around the entirety of the perimeter of the wall of the fluid passage. The plane defined by the shelf is substantially perpendicular to the axis of travel of fluid through the fluid passage (7). The shelf (9) may be located at a variety of locations within the housing (1). The shelf (9) may be located substantially at the midpoint of the housing (1), or between the midpoint of the housing (1) and the first end (3). The shelf (9) is preferably located at a point between the midpoint of the housing (1) and the second end (5). Alternatively, the shelf (9) may be formed by one or more portions of the face of the inlet of the second end cap (21).

Embodiments of the invention further comprise a first end cap (11) detachably attached to the first end (3). The first end cap (11) comprises a first inlet (13), a first outlet (15), and a seat (17). In this embodiment, the first inlet (13) comprises the initial entry point of fluid into the check valve assembly. The seat (17) is disposed around the face of the first outlet (15) facing the second end (5). In embodiments, the seat (17) comprises a bevel in the face of the first outlet (15) configured to mate sealably with the poppet head (19). The first outlet (15) comprises the general area in which fluid leaves the portion of the check valve assembly defined by the first end cap (11) and pushes the poppet (25) away from the seat (17). Fluid moves from the first inlet (13) to the first outlet (15), past the poppet head (29), and down the fluid passage (7) in the direction of the second end (5). The opening defined by the first outlet (15) has a cross-sectional area smaller than the cross-sectional area of the fluid passage (7) exclusive of the shelf (9). The opening defined by the first outlet (15) is sized to prevent travel of the retainer (23) past the first outlet (15), such as in the event of catastrophic failure of the poppet (25).

These embodiments of the present invention further comprise a second end cap (21) detachably attached to the second end (5). The second end cap (21) comprises a second inlet (29) and a second outlet (27). The second inlet (29) comprises general area in which fluid flowing from the direction of the first end (3) enters the second end cap (21). The second outlet (27) comprises the exit point of fluid from the check valve assembly. In one embodiment hereof, one or more portions of the face of the opening defined by the second inlet (29) comprises a shelf (9).

In these embodiments, the first end (3) and a portion of the first end cap (11) are cooperatively threaded for threaded engagement of the first end cap (11) to the first end (3). Similarly, the second end (5) of the housing (1) and a portion of the second end cap (21) are cooperatively threaded for threaded engagement of the second end cap (21) to the second end (5). In this way, the check valve assembly can be easily disassembled for service, removal, or replacement of internal parts. The first end (3) and first end cap (11), second end (5) and second end cap (21), or both, may be connected in manners other than by threaded engagement. Any form of connection suitable for plumbing or gas flow applications may be used, as will be appreciated by one skilled in the art. Suitable forms of connection include, by way of example, press-on connection, soldered connection, sweated connection, cemented connection, clamped connection, and friction fit connection. As will be appreciated by one skilled in the art, washers, rubber washers, gaskets, cements, epoxies, or sealants may be used to enhance the connection between the housing and the first end cap (11), second end cap (21), or both.

Further, in these embodiments, a portion of at least one of the first end cap (11) or the valve body is adapted for engagement with the outlet valve of a pump, preferably a submersible pump. This adaptation is preferably male threading located on the external face of the first end cap or valve body, sized and configured for threaded engagement with the female threads of a pump outlet. Most preferably, this male threading is configured for threaded engagement with 1.25″ female threading, as is commonly located within submersible pump outlets. One skilled in the art would appreciate that a variety of connection means and sizes could be used to connect a check valve within the teachings of this invention to a submersible pump. For example, connection by way of soldering, friction, cement, adhesive, or other known connection means, as would be appreciated by one skilled in the art.

In these embodiments, a poppet assembly is located within the fluid passage (7). The poppet assembly comprises a retainer (23), a biasing member (38), and a poppet (25). The retainer (23) comprises a sleeve (31) adapted to retain the poppet (25). The retainer (23) is oriented within the fluid passage (7) so that the opening defined by the sleeve (31) is generally coaxial with the overall direction of travel of fluid. The retainer further comprises one or more feet (33) extending substantially perpendicularly from the sleeve (31). The feet are collectively sized to define an area smaller than the area of the fluid passage (7) exclusive of the shelf (9), but larger than the shelf (9), such that when the retainer (23) is placed within the housing in the proper orientation the feet (33) cannot travel past the shelf (9). The “feet” may comprise a single unitary structure, such as a ring, or may comprise one or more outwardly-depending protrusions from the sleeve (31). Preferably, the feet comprise at least three equally spaced outwardly-depending protrusions, and, most preferably, the feet comprise four equally-spaced outwardly depending protrusions. As will be appreciated by one skilled in the art, a large variety of numbers, shapes, sizes, and configurations of feet are possible within the scope and spirit of this invention.

A removable poppet (25), comprised of a head (19) and a stem (35), is slidably engaged with the retainer (23). The poppet (25) is positioned within the valve so that the stem (35) is within the sleeve (31) and the head (19) faces the seat (17). The poppet head (19) is shaped to cooperate with the seat (17) to form a releasable sealed engagement when the biasing member (38) presses the head (19) against the seat (17). A removable biasing member (38) is located between the poppet head (19) and the retainer feet (33) and is adapted to bias the poppet head (19) against the seat (17). Preferably in these embodiments, the biasing member (38) is retained between the poppet head (19) and retainer feet (33). The poppet (25) in these embodiments preferably comprises a collar (20) on a face of the head (19) opposite the face of the head (19) that seals to the seat, which assists the poppet (25) in aligning with the sleeve (31) when the poppet (25) is under pressure in the forward flow direction. Optionally, the collar (20) may align with a cooperative bevel in the face of the opening defined by the sleeve (31).

The biasing member (38) biases the poppet head (19) against the seat (17) such that when fluid subject to pressure of a desired minimum level moving in the appropriate direction encounters the poppet (25), the poppet head (19) slides away from the seat (17) towards the second end (5) allowing the fluid to pass into the housing (1). As long the fluid is subject to sufficient pressure in the appropriate direction, fluid will pass the poppet head (19) and pass through the check valve in the direction of travel from the first inlet (13) to the second outlet (29). If pressure in the appropriate direction becomes insufficient, or if pressure from the reverse direction is applied, the head (19) is biased back into substantially sealed engagement with the seat (17), substantially preventing the reverse flow of fluid through the valve.

In a second embodiment, the check valve of the present invention comprises a two-piece assembly. In this embodiment, the check valve comprises a body comprising a first piece (37) detachably attached to a second piece (39), with a fluid passage (41) running through the first piece (37) and second piece (39).

The first piece (37) comprises a first inlet (43), a first outlet (47) and a portion of the fluid passage (41). A seat (45) is disposed around the inner face of the first inlet (43). The seat (45) comprises a bevel or a shelf in the inner face of the first inlet (43) configured to mate sealably with a poppet head (19).

The second piece (39) comprises a second inlet (49), a second outlet (51), a portion of the fluid passage (41), and a stem enclosure (101). A portion of the first piece (37) disposed toward the first outlet (47) comprises internal threading, and a portion of the second piece (39) disposed towards the second inlet (49) comprises cooperative external threading such that the first piece (37) and second piece (39) detachably connect by threaded engagement. As will be appreciated by one skilled in the art, the threading may be reversed. In this way, the check valve assembly can be easily disassembled for service, removal, or replacement of internal parts. As will be appreciated by one skilled in the art, a variety of means of mechanical connection may be used to detachably attach the first piece (37) to the second piece (39) within the scope and spirit of this invention. Any form of connection suitable for plumbing or gas flow applications may be used, as will be appreciated by one skilled in the art. Suitable forms of connection include, by way of example, press-on connection, soldered connection, sweated connection, and friction fit connection. As will be appreciated by one skilled in the art, washers, rubber washers, gaskets, cements, epoxies, or sealants may be used to enhance the connection between the first piece (37) and second piece (39).

The stem enclosure (101) comprises a sleeve to slidably retain the poppet stem. The stem enclosure (101) is disposed substantially in the center of the fluid passage defined by the second piece. The stem enclosure (101) is held in axial alignment with the poppet stem by one or more, and in the depicted embodiment, 2, supporting members connecting the stem enclosure (101) to the valve body. Preferably in these embodiments, the stem enclosure (101) extends beyond the end of fluid passage. Preferably in these embodiments, the external surface of the stem enclosure (101) is configured in a hex profile, which allows it to operate with secondary function as a turning aid for installation of the valve in the outlet of a pump.

Further, a portion of the outer circumference of the second piece (39) is adapted for threaded engagement with the outlet of a submersible pump, preferably in standard sizes, and most preferably in the size of 1.25 inch. Preferably in these embodiments, a portion of the outer circumference of the second piece (39) comprises male threading configured for threaded engagement with the female threading in the outlet of a submersible pump. One skilled in the art would appreciate that a variety of different or alternate configurations could be used to achieve connection between the check valve of the present invention and a submersible pump outlet, including the use of connection types other than threaded connection or differing sizes or configurations. For example, the first piece (37), or second piece (39), or both could be selected or adapted for male or female connection to the outlet of a submersible pump, or could be selected or adapted to connect to the same by way of threading, soldering, friction, cement, adhesive, or other known connection means as would be appreciated by one skilled in the art. By replacing one or more of the first piece (37) or second piece (39) with alternative pieces configured to fit to outlets of different sizes or configurations, or using different connection means, a user may easily adapt the check valve of this embodiment for engagement with a wide variety of submersible pumps.

A poppet assembly is located within the fluid passage (41). The poppet assembly comprises a biasing member (38), and a poppet (25).

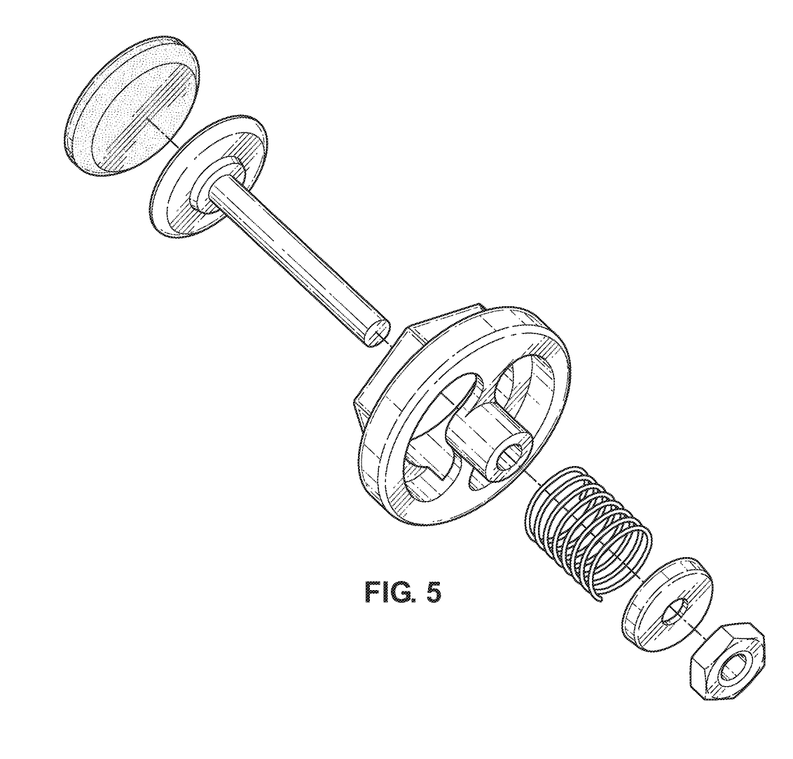

A removable poppet (25), comprised of a head (19) and a stem (35), is slidably engaged with the stem enclosure (101). The poppet (25) is positioned so that the stem (35) is within the stem enclosure (101) and the head (19) faces the seat (45). The poppet head (19) is shaped to cooperate with the seat (45) to form a releasable sealed engagement when the biasing member (38) presses the head (19) against the seat (45). A removable biasing member (38) is located between the head (19) and a face of the stem enclosure (101) and adapted to bias the head (19) against the seat (45). Preferably in these embodiments, the poppet (25) comprises a collar (20) on the head (19) opposite the face of the head (19) that seals to the seat, which assists the poppet (25) in aligning with the stem enclosure (101) when the poppet (25) is under pressure in the forward flow direction. Optionally, the collar (20) may align with a cooperative bevel in the face of the opening defined by the stem enclosure (101). In some embodiments, the poppet head is comprised entirely of metal. In some embodiments, as depicted in FIG. 5, the poppet head may be comprised of metal with a removable rubber cover surface. Preferably in these embodiments, the poppet head (19) is comprised of or non-removably coated with rubber.

The biasing member (38) biases the head (19) against the seat (45) such that when fluid under pressure of a desired minimum level moving in the appropriate direction encounters the poppet (25), the poppet (25) slides away from the seat (45) towards the second outlet (51) allowing the fluid to pass through the first inlet (43). As long as sufficient pressure is applied in the appropriate direction, fluid will pass into the first inlet (41), past at least one face of the stem enclosure (101), and exit the valve assembly through the second outlet (51). If pressure in the appropriate direction ceases or pressure from the reverse direction is applied, the head (19) is biased back into substantially sealed engagement with the seat (45), substantially preventing the reverse flow of fluid through the valve.

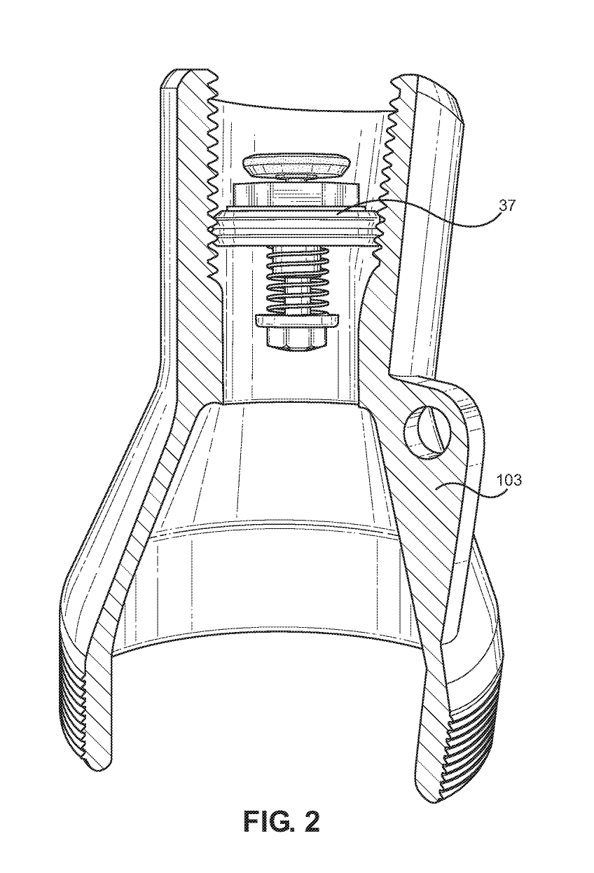

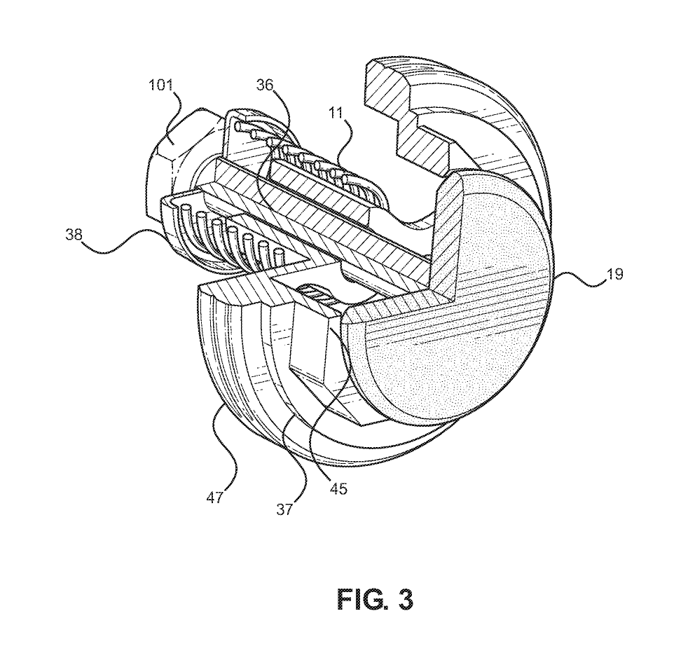

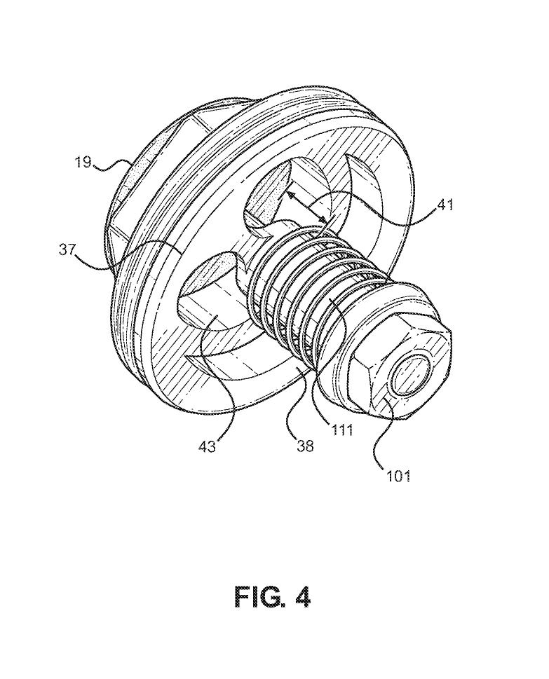

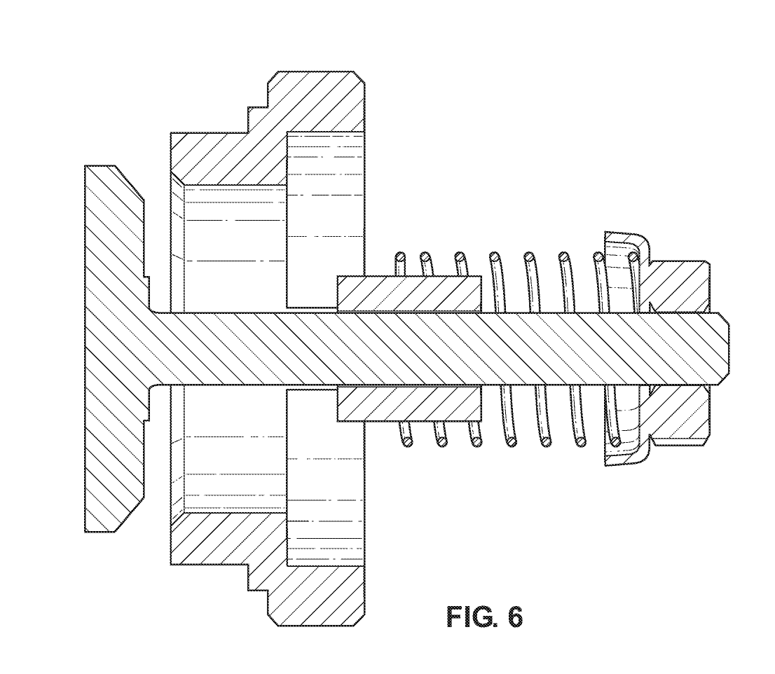

In a preferred embodiment, as shown in FIGS. 2-6, the check valve of the present invention comprises a unibody assembly. In this embodiment, the check valve comprises a unibody housing,(37), with a fluid passage (41) running through the unibody housing (37).

The unibody housing (37) comprises a first inlet (43), a first outlet (47) and a fluid passage (41). A portion of the first outlet (47) comprises a seat (45), which is disposed around the face of the first outlet (57).

The unibody housing (37) further comprises a stem enclosure (101), as shown in in FIGS. 2-6. The stem enclosure (101) preferably comprises a sleeve to slidably retain the poppet stem. The stem enclosure (101) is preferably disposed axially substantially at the center of the circle defined by the cross-section of the unibody housing (37). Preferably, the stem enclosure (101) is held in axial alignment by one or more, and in the depicted embodiment, two, supporting members (201). In this way, the stem enclosure (101) can be located in the flow path of the fluid passage (41). In this preferred embodiment, the stem enclosure (101) extends beyond the end of fluid passage. In this preferred embodiment, the external surface of the stem enclosure (101) is configured in a hex profile, which allows it to operate with secondary function as a turning aid for installation of the valve in the outlet of a pump.

In the embodiments shown in FIGS. 2-6, a portion of the stem enclosure (101) forms a retaining member to retain one end of the biasing member (38), with the opposite end of the biasing member (38) being retained by the supporting members connecting the stem enclosure to the valve body. A removable poppet (25), comprised of a head (19) and a stem (35) is slidably engaged with the stem enclosure (101). The poppet (25) is positioned so that the stem (35), but not the stem base (111) is within the stem enclosure (101). The stem base (111) may include a washer or other structure with a diameter larger than the exterior diameter of the stem enclosure (101). The stem (35) traverses the first inlet (43) and first outlet (47) so that the rear of the poppet head (19) faces the seat (45) formed by the first outlet (47). The poppet head (19) rear is shaped to cooperate with the seat (45) to form a releasable sealed engagement when the biasing member (38) presses the rear of the poppet head (19) against the seat (45).

The biasing member (38) biases the poppet head (19) against the seat (45) such that when fluid under pressure of a desired minimum level moving in the appropriate direction encounters the poppet (25), the poppet (25) slides away from the seat (45) away from the first outlet (47) allowing the fluid to pass through the second inlet and second outlet. As long as sufficient pressure is applied in the appropriate direction, fluid will exit the valve assembly through the first outlet (47). If pressure in the appropriate direction ceases or pressure from the reverse direction is applied, the poppet head (19) is biased back into substantially sealed engagement with the seat (45), substantially preventing the reverse flow of fluid through the valve.

Further, a portion of the outer circumference of the unibody housing (37) may be adapted for threaded engagement with the outlet of a submersible pump, preferably in standard sizes, and most preferably in the size of 1.25 inch. In A portion of the outer circumference of the unibody housing (37) may comprise male threading configured for threaded engagement with the female threading in the outlet of a submersible pump. One skilled in the art would appreciate that a variety of different or alternate configurations could be used to achieve connection between the check valve of the present invention and a submersible pump outlet, including the use of connection types other than threaded connection or differing sizes or configurations. For example, the unibody housing (37) could be selected or adapted for male or female connection to the outlet of a submersible pump, or could be selected or adapted to connect to the same by way of threading, soldering, friction, cement, adhesive, or other known connection means as would be appreciated by one skilled in the art. By replacing one or more of the unibody housing (37) with alternative pieces configured to fit to outlets of different sizes or configurations, or using different connection means, a user may easily adapt the check valve of this embodiment for engagement with a wide variety of submersible pumps.

Embodiments of the present invention can be manufactured or made from a variety of materials, as will be understood by one skilled in the art. Metals and metal alloys such as, for example, carbon steel, impact tested carbon steel, low temperature service carbon steel, stainless steel, malleable iron, non-ferrous metals, and chrome-molybdenum steel, non-metallic substances such as ABS, FRE, HDPFE, tempered glass, PVC, and other plastics, elastomers such as rubber, overmolded metals, and overmolded non-metallic materials, can all be used to for one or more parts of the check valve assembly taught herein, as will be appreciated by one skilled of the art In preferred embodiments, the body of the check valve and the retainer are made of metal, preferably by machining.

Although the invention herein has been described with regard to specific embodiments, it will be understood that the invention is not limited to these embodiments. Alternative materials, manners of assembly or connection, retainer shapes or sizes, poppet shapes or sizes, or biasing means other than those expressly depicted herein may be used within the scope and spirit of this invention.

What is claimed is:

1. A check valve for use in a submersible pump comprising:
(a) a unibody housing comprising a first inlet and a first outlet opposite said first inlet, wherein a portion of said first outlet comprises a seat;
(b) a fluid passage connecting said first inlet to said first outlet;
(c) one or more support members disposed within said fluid passage and connected to said unibody housing;
(d) a stem enclosure connected to said one or more support members and disposed axially with respect to said fluid passage;
(e) a poppet comprising a head, a stem, and a stem base, wherein said stem is slidably engaged with said stem enclosure, said poppet is partially retained within said stem enclosure by said stem base, and the back face of said poppet head is realasably sealedly engaged with said seat
(f) a biasing member captured between said one or more support members and said stem base, wherein said poppet head is releasably sealedly engaged with said seat when said poppet is biased by said biasing member into a closed position.

2. The check valve of claim 1, wherein said biasing member comprises a spring.

3. The check valve of claim 2, wherein said unibody housing further comprises threading around its outer circumference for connection to a submersible pump.

4. The check valve of claim 3, wherein said threading comprises male threading.

5. The check valve of claim 3, wherein said threading comprises female threading.
